(19) United States
(12) Patent Application Publication
(10) Pub. No.: US 2015/0085604 A1
(43) Pub. Date: Mar. 26, 2015

(54) APPARATUS, SYSTEM, AND METHOD FOR REAL-TIME SEISMIC DATA ACQUISITION MANAGEMENT

(71) Applicant: Ubiterra Corporation, Denver, CO (US)

(72) Inventor: Peter W. Flanagan, Denver, CO (US)

(73) Assignee: Ubiterra Corporation, Denver, CO (US)

(21) Appl. No.: 14/493,145

(22) Filed: Sep. 22, 2014

Related U.S. Application Data
(60) Provisional application No. 61/880,724, filed on Sep. 20, 2013.

(51) Int. Cl. G01V 1/22; G01V 1/00

(52) U.S. Cl. CPC G01V 1/22; G01V 1/003
USPC 367/14

(57) ABSTRACT

Implementations described and claimed herein provide apparatuses, systems, and methods for real-time seismic data acquisition management. In one implementation, seismic data captured using one or more monitoring devices at a remote seismic exploration project site is received. A seismic field record is detected in the captured seismic data automatically using at least one processor, and a network connection with a cloud storage array is established. The detected seismic field record is automatically sent to the cloud computing array over the network connection.

### CROSS-REFERENCE TO RELATED APPLICATIONS

The present application claims benefit of priority under 35 U.S.C. §119(e) to U.S. Provisional Patent Application No. 61/880,724, entitled “Apparatus, System and Method for Real-Time Data Capture, Quality Control, and Team Collaboration for Seismic Data Acquisition” and filed on Sep. 20, 2013, specifically incorporated by reference in its entirety herein.

### TECHNICAL FIELD

Aspects of the present disclosure relate to data acquisition, quality control, processing, analysis, sharing, and storing services, among other functions, and more particularly to real-time seismic data acquisition management.

### BACKGROUND

Many scientific fields involve the collection of sample data in a 3-dimensionally organized form. For example, seismic exploration data, collected in an effort to identify natural gas, oil, water, and/or other underground resources, involves data in x and y horizontal planes and in a z-plane, which is typically associated with time. To collect field seismic data, sometimes referred to as raw seismic data, a seismic survey is conducted, involving seismic waves that are created on the surface. The seismic waves may be initiated in any number of ways, including, for example, through the use of explosives or seismic vibrators. As the seismic waves propagate downward, portions of the waves reflect back to the surface when the waves interact with an underground object, layer, or any number of other possible underground features. The reflected wave data is collected over a wide geographical area. This field seismic data is stored and converted, such as through a process sometimes referred to as stacking, into a form, such as a seismic stack, that can show various underground objects and features in a human readable way through various types of software and user interfaces. Geologists, geophysicists, and others using the processed data and tools can then interpret the data to identify those features associated with the presence of natural gas, shale, oil, water, and other things.

In the case of a seismic stack, the processed stack data is often viewed as various slices or cross-sections taken along the x-axis (inline), the y-axis (cross-line), the z-axis (slice or time direction), or some combination thereof. Since the stack represents a 3-D image of a large underground cube, by viewing various slices through the data, changes in features, underground shapes and contours, and numerous other characteristics of the data may be identified. These data sets are often massive, in some instances on the order of tens or more gigabytes of data. Visualizing and working with the data requires large amounts of fast data storage and processors.

Consequently, seismic data is processed and analyzed remotely from an acquisition site. Because seismic acquisition takes place in remote areas, costs to deploy highly trained acquisition contractors in the field are increased (e.g., approximately $40,000 per square mile), intensifying the necessity of quality control. However, the time pressure involved in executing drilling decisions based on the seismic data can incentivize an acquisition contractor to emphasize the prompt provision of the seismic acquisition data for the mapping and interpretation process at the expense of the quality of the acquisition process.

The conventional methodology for the management of seismic data involves complex data flow and coordination among multiple parties, such as contractors, owners, and partners, among others. These methods are generally inefficient and prone to data loss and disclosure risk. For example, an acquisition contractor may save collected field seismic data to a thumb drive, which is mailed to the owner, partner, or another contractor for review and analysis. Accordingly, a mechanism is needed that effectively and efficiently captures and shares high quality seismic data and that provides a quality control check of the seismic data in substantially real-time.

It is with these observations in mind, among others, that various aspects of the present disclosure were conceived and developed.

### SUMMARY

Implementations described and claimed herein address the foregoing problems by providing an apparatus, system, and methods for real-time seismic data acquisition management. In one implementation, seismic data captured using one or more monitoring devices at a remote seismic exploration project site is received. A seismic field record is detected in the captured seismic data automatically using at least one processor, and a network connection with a cloud storage array is established. The detected seismic field record is automatically sent to the cloud computing array over the network connection.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example system for real-time seismic data acquisition management and sharing.

FIG. 2 shows an example seismic data application running on a server or other computing device coupled with a network for receiving and pre-processing seismic data.

FIG. 3 depicts an example system for managing the flow of and access to seismic data.

FIG. 4 is a flow chart illustrating example operations for real-time seismic data acquisition management.

FIG. 5 shows an example computing system that may implement various systems and methods discussed herein.

### DETAILED DESCRIPTION

Aspects of the present disclosure involve apparatuses, systems, and methods for managing the flow of and access to proprietary data sets, such as seismic data sets or other large data sets, in cloud-based computing architectures and other architectures. In one particular aspect, field seismic data is acquired and uploaded to a cloud infrastructure in substantially real time via a high bandwidth satellite as facilitated by a field application and a seismic data application. The field seismic data may be in the form of shot records along with field conditions data and/or ancillary data. Often the field seismic data involves a tremendous number of channels or lines of data taken over a period of time. The seismic data application, thus, automatically pre-processes and quality checks the field seismic data as it is made immediately available to various parties involved in the project, including, without limitation, an owner that commissioned the seismic survey, any partners of the owner, and any number of contractors or other authorized parties. These parties are thus enabled to perform their own quality checks.

Once the acquisition of the field seismic data is complete, the field seismic data is downloaded for processing to generate multi-dimensional (e.g., 2-dimensional or 3-dimensional) seismic stack data or may be retained in and processed in the cloud infrastructure. The processed seismic data may be accessed to interpret the data, for example, to identify underground horizons, obtain topographic data, obtain filtered data, and/or obtain fault data.

The various apparatuses, systems, and methods disclosed herein provide for the acquisition and real-time transmission of raw massive multi-dimensionally organized data from a remote site via a network connection (e.g., via a satellite) to a storage infrastructure, such as a cloud infrastructure, for quality control and real-time access by project personnel, along with numerous other advantages and efficiencies over conventional methodologies. The example implementations discussed herein reference the multi-dimensional data as a 3-dimensional data seismic stack. However, it will be appreciated by those skilled in the art that the presently disclosed technology is applicable to 2-dimensional seismic data, as well as other types of massive data, including, but not limited to, medical data (e.g., magnetic resonance imaging (MRI), CT scans, and other medical imaging data), oceanic data, weather data, geological data, and other scientific data.

Some details of the management, storage, retrieval, and sharing of massive proprietary data in a cloud storage array are disclosed more fully in: U.S. application Ser. No. 13/654,316 entitled “Apparatus, System, and Method for the Efficient Storage and Retrieval of 3-Dimensionally Organized Data in Cloud-Based Computing Architectures” and filed on Oct. 17, 2012; U.S. application Ser. No. 13/657,490 entitled “A System, Method, and Apparatus for Proprietary Data Archival, Directory and Transaction Services” and filed on Oct. 22, 2012; and U.S. application Ser. No. 13/741,272 entitled “Apparatus, System, and Method for Managing, Sharing, and Storing Seismic Data” and filed on Jan. 14, 2013. These applications are each hereby incorporated by reference in their entirety herein.

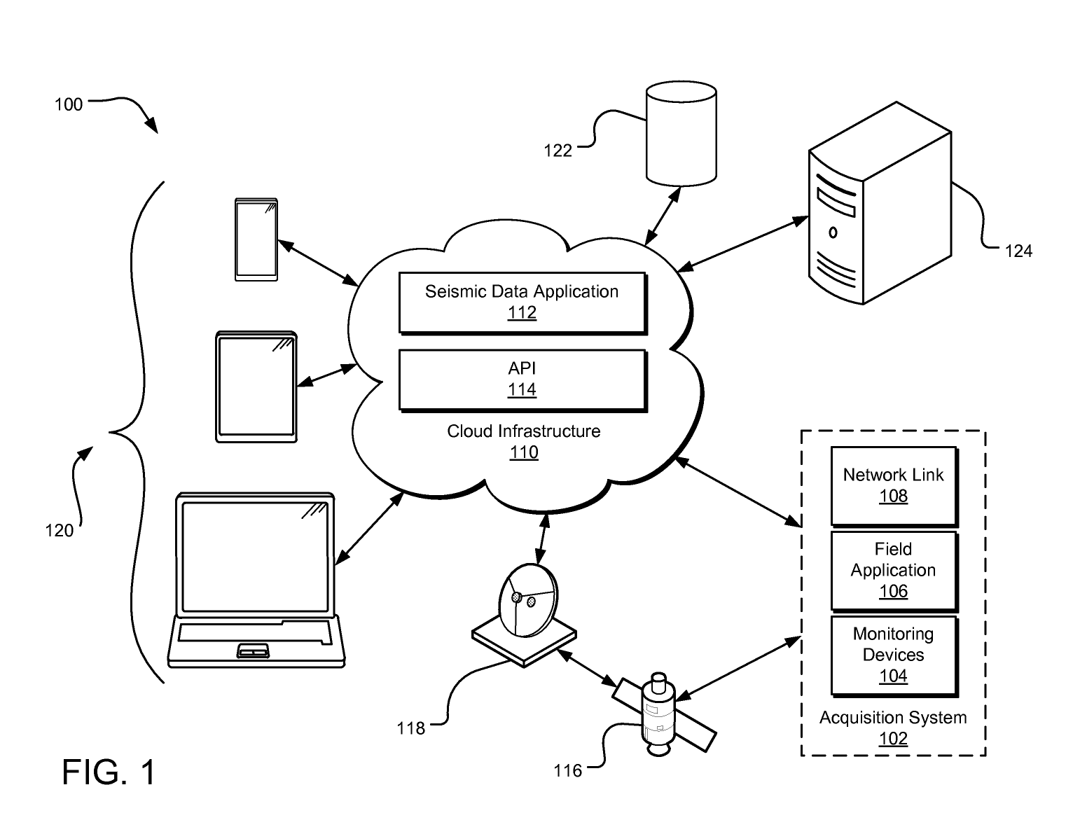

For a detailed description of an example system 100 for real-time seismic data acquisition management and sharing, reference is made to FIG. 1. In one implementation, the system 100 has a cloud-based computing and storage architecture providing the capability to acquire, store, upload, download, view, access, and manipulate seismic data, including 3-dimensional seismic stack data, otherwise known as a cube, for the efficient implementation of an incrementally built field stack.

In one implementation, an acquisition system 102 is deployed on-site, generally at a remote location. The site may be, for example, the site of a commissioned a seismic survey for oil, gas, and/or mineral drilling. In one implementation, the acquisition system 102 is a seismic recording or transcription vehicle (e.g., a truck) configured to capture seismic field records using one or more monitoring devices 104. The acquisition system 102 may also be another mobile or stationary structure. The monitoring devices 104 may be any device configured to record, transcribe, or otherwise capture data on-site including, without limitation, seismic monitoring devices (e.g., seismograph recorders or transcribers), project field conditions monitoring devices, and the like.

The monitoring devices 104 are in communication with a field application 106 running on a server or other computing device in communication with a network via a network link 108. In one implementation, the network includes a seismic data application 112 implemented in a cloud infrastructure 110, which provides login control, audit trails, rights management, and administrative services. Generally, the seismic data application 112 may manage a seismic field acquisition project, including team members, and provide various processing algorithmic parameters for the automatic preparation of a field stack and for signal quality threshold parameters.

In one implementation, a user may access and interact with the seismic data application 112 from the field application 106 utilizing an interface such as an application programming interface (API) 114. Stated differently, the API 114 can be called from the field application 106 or other software to pull or push seismic data to and from the cloud infrastructure 110.

The network link 108 may be configured to connect to the cloud infrastructure 110 in a variety of manners, including, without limitation, a wireless connection, a wired connection, and other internet network connections. Due to the remoteness of many sites, in one implementation, the network link 108 establishes a connection with a satellite 116, which connects to the cloud infrastructure 110 via a satellite dish 118 or similar device. Data, including field records, field condition data, and ancillary data, may be uploaded to the satellite and downloaded for access or storage via the cloud infrastructure 110. The speed of the connection with the satellite 116 may be optimized to make the captured data to be visible to one or more users accessing the seismic data application 112 from a user device 120 in substantially real-time. For example, the upload time for a shot record may range from 5.8 seconds (400 channels) to 2.4 minutes (10,000 channels) at 7 Mbps; from 8.2 seconds (400 channels) to 3.4 minutes (10,000 channels) at 5 Mbps; and 13.6 seconds (400 channels) to 5.7 minutes (10,000 channels) at 3 Mbps. For a typical shot record at 2,500 channels, the upload time may be approximately 36 seconds at 7 Mbps, 51 seconds at 5 Mbps, and 85 seconds at 3 Mbps.

The user device 120 is generally any form of computing device capable of interacting with the cloud infrastructure 110, such as a personal computer, terminal, workstation, portable computer, mobile device, tablet, multimedia console, and the like. The cloud infrastructure 110 is used by one or more computing or data storage devices (e.g., one or more databases 122 or other computing units described herein) for implementing the seismic data application 112 and other services, applications, or modules in the cloud infrastructure 110.

In one implementation, the cloud infrastructure 110 includes at least one server 124 hosting a website or an application that the user may visit to access the seismic data application 112 and/or other network components. The server 124 may be a single server, a plurality of servers with each such server being a physical server or a virtual machine, or a collection of both physical servers and virtual machines. The user devices 120, the server 124, and other resources connected to the cloud infrastructure 110 may access one or more other servers to access to one or more websites, applications, web services interfaces, storage devices, computing devices, or the like that are used for the management, processing, and analysis of seismic data. The server 124 may also host a search engine that the seismic data application 112 uses for accessing, searching for, and modifying seismic data.

The field application 106 is configured to obtain seismic data from the monitoring devices 104 and send the seismic data to the seismic data application 112, for example, via the satellite 116. In one implementation, the field application 106 monitors a file system directory to which newly acquired field records are written are capture by the monitoring devices 104. When the field application 106 detects a new record in the file system directory, the field application 106 uploads the record to a designated project area within the cloud infrastructure 110, accessible by the user devices 120 with the seismic data application 112. In one implementation, the field application 106 sends a message to the seismic data application 112, for example, into a message notification queue, indicating that a new seismic field record has been recorded and is available for a project.

As discussed herein, the monitoring devices 104 are configured to capture data at the project site, including seismic field records, field condition data, and ancillary data. The field condition data may include, without limitation, telemetry, such as wind speed, temperature, and Global Positioning System (GPS) position, and other data pertaining to the conditions at the project site. The ancillary data may include any data pertaining to the project, including, but not limited to, daily reports, observer field notes, location surgery files, geometry files, and the like. In one implementation, the field application 106 detects and attaches the field condition data and ancillary data to the project in the seismic data application 112.

In one implementation, the monitoring devices 104 include a seismic transcription system where seismic data accumulates in a remote device(s) for a period of hours to days. At the end of that period, the seismic data accumulated in the remote device(s) is downloaded and stored within the seismic transcription system at the project field location. The field application 106 then detects a new record in the file system directory and uploads the record to the seismic data application 112.

Upon receiving a message from the field application 106 that a new seismic field record has been uploaded, in one implementation, the seismic data application 112 automatically processes the seismic field record and adds the record to a field stack/cube. The seismic data application 112 may further analyze the seismic field record for signal and/or noise content. In one implementation, if preset thresholds are exceeded, the seismic data application 112 automatically issues a notification to team members. The notification may be, for example, an email, text, user interface alert, or other alerts or messages. In one implementation, the seismic data application 112 assesses production rate (field recordings per hour). Using the production rate and field condition data (e.g., wind speed), the seismic data application 112 updates production data and automatically issues production progress reports to one or more authorized users for the project. The progress reports may be sent on a regular basis, upon manual command, at preset intervals, or the like.

The seismic data application 112 includes security measures to ensure only user authorized for a project may access and interact with data for the project. In one implementation, the seismic data application 112 includes a login at which time the seismic data application 112 automatically identifies the user as an authorized member of a particular acquisition project team. The seismic data application 112 then presents the user with a summary of a current status of the seismic acquisition project. For example, the summary may include, without limitation: a number of seismic field records recorded; a number of seismic field records uploaded; a backload to be uploaded; a status of the field stack; a map view of the production progress and seismic dataset properties, such as seismic fold (multiplicity) at each bin (image location) and seismic azimuth distribution at each bin; a production rate summary graph over the duration of the project; ambient conditions at the project field location, including, without limitation, wind speed, temperature, micro-weather report, and location (e.g., GPS coordinates); and field reports and observer notes authored and updated by the acquisition contractor crew member(s).

In one implementation, a user may view and analyze seismic field records for a project with the user device 120 using the seismic data application 112. For example, the user may view a field record and adjust various display parameters for the record. The seismic data application 112 generates one or more analyses of the field record, such as spectral analysis, coherent (surface) noise analysis, random noise (signal to noise ratio) analysis, and stacking velocity analysis.

The seismic data application 112 provides the ability to view and manipulate automatically accumulated seismic field stacks. In one implementation, the seismic data application 112 permits the adjustment of display parameters (e.g., automatic gain control and band pass filters) and the adjustment of preset stacking algorithmic parameters. Adjusting the stacking algorithmic parameters causes the seismic field stack to reinitialize and restack from all the seismic field records uploaded to date for the project. At that point, the stack will continue to automatically build as new field records are uploaded.

Seismic field records and seismic field stacks may be downloaded and transmitted across various team members and authorized users, as described herein, using the seismic data application 112. In one implementation, team members may download current and new data on demand, as needed, using the seismic data application 112. In another implementation, the seismic data application 112 may automatically relay seismic field records as captured to various team members using an automatic transmission protocol, such as file transfer protocol (FTP). It will be appreciated that other seismic data, such as field condition data and ancillary data, may be similarly transmitted and downloaded using the seismic data application 112. In one implementation, the seismic data application 112 maintains a permanent archive of seismic data for a project, including the seismic field records and seismic field stack, as well as any other field condition or ancillary data.

As described herein, the system 100 provides many advantageous features, including, without limitation, the promotion of team collaboration on a project, secured data, access to captured field records in substantially real time, and automatic analysis and quality control. The field application 106 captures seismic records as soon as the records are recorded or transcribed using the monitoring devices 104, and the acquisition system 102 transmits the seismic field records upon capture to the cloud infrastructure 110, even from remote locations. Once the field records are received, the seismic data application 112 automatically analyzes each field record to determine whether quality control criteria are satisfied and to process the field record for adding to the field stack, which may be used to provide an early analysis of the subsurface exploration target of the project and to further assess the quality of the seismic data. The seismic data application 112 further monitors the production rate of the acquisition project. During the quality control check of the field records, if ongoing analysis of the captured data indicates that a pre-determined threshold has been exceeded, such as a signal-to-noise ratio of a seismic field record, the seismic data application 112 automatically notifies responsible team members of the issue and may require correction. Similarly, team members may provide feedback to the acquisition contractor to request adjustments to acquisition project parameters to optimize data quality and production rate.

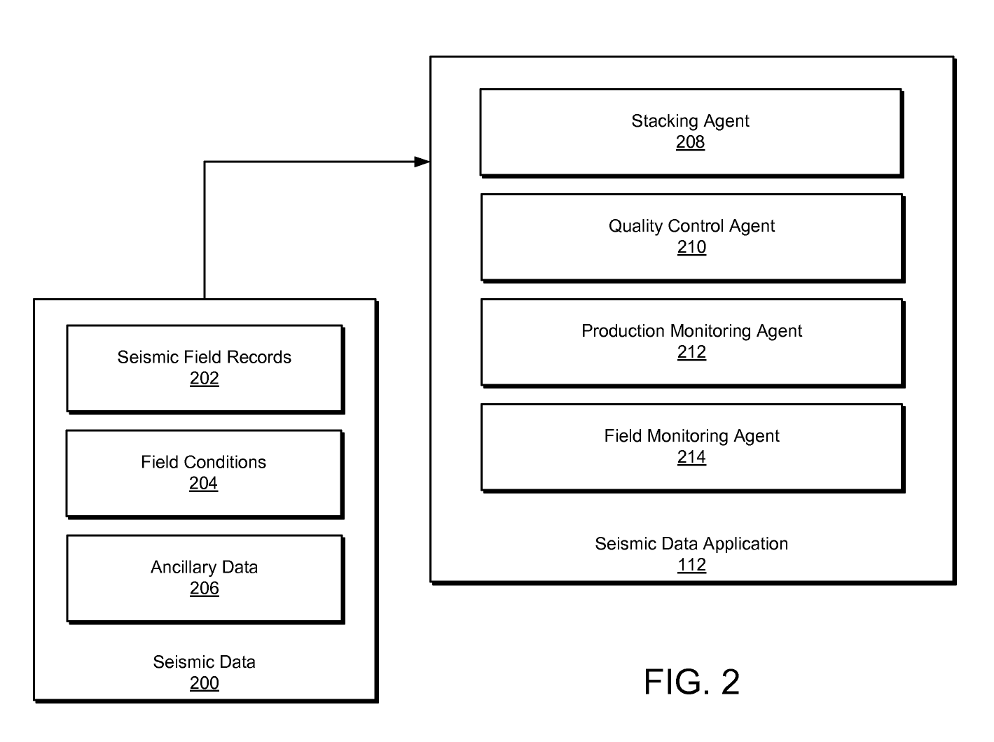

Turning to FIG. 2, which shows an example seismic data application 112 running on a server or other computing device coupled with a network for receiving and pre-processing seismic data 200.

Seismic data 200 is transmitted to the seismic data application 112, as described herein. In one implementation, the seismic data 200 is captured from a plurality of monitoring devices, including seismic monitoring devices and field condition monitoring devices, at a remote project field site. The seismic monitoring device may be a geophone configured to establish a network connection with remote storage, for example, using a satellite. The seismic data 200 is uploaded to the satellite using the geophone and downloaded to the remote storage, where it is accessible using the seismic data application.

In one implementation, the seismic data 200 includes seismic field records 202, field condition data 204, and ancillary data 206. The field condition data 204 may include, without limitation, wind speed, temperature, precipitation rate, location data (e.g. GPS position), and other data pertaining to the conditions at the project site. The ancillary data 206 may include any data pertaining to the project, including, but not limited to, daily reports, observer field notes, location surgery files, geometry files, and the like. In one implementation, the field condition data 204 and/or the ancillary data 206 is transmitted to the seismic data application 112 at the same or a higher frequency as the frequency of uploading the seismic field records 202.

The seismic data application 112 may include various agents configured to automatically process and analyze the seismic data 200 upon capture. In one implementation, the seismic data application 112 includes a stacking agent 208, a quality control agent 210, a production monitoring agent 212, and a field monitoring agent 214. The stacking agent 208 is configured to detect receipt of a seismic field record 202 at the remote storage and stack the detected field record with one or more existing field records previously received to make a current seismic field stack. The quality control agent 210 is configured to analyze the field record 202 to determine whether the field record 202 meets pre-defined quality control standards. For example, the quality control agent 210 may analyze a signal-to-noise ratio of the field record 202 to determine whether the field record 202 meets noise quality standards. If the quality control parameters (e.g., signal-to-noise ratio) of the field record 202 meets a threshold, the quality control agent 210 automatically generates and transmits a notification to one or more project members. The production monitoring agent 212 is configured to analyze the rate of production of the seismic field records 202 to ensure the project is on schedule. If the production rate meets a threshold, the production monitoring agent 212 automatically generates and transmits a notification to one or more project members. The field monitoring agent 214 is configured to analyze the field condition data 204 and similarly automatically generate and transmit a notification to one or more project members where the field condition data 204 meets a threshold to ensure seismic field records 202 are captured in the most efficient manner and to ensure that quality control standards are met.

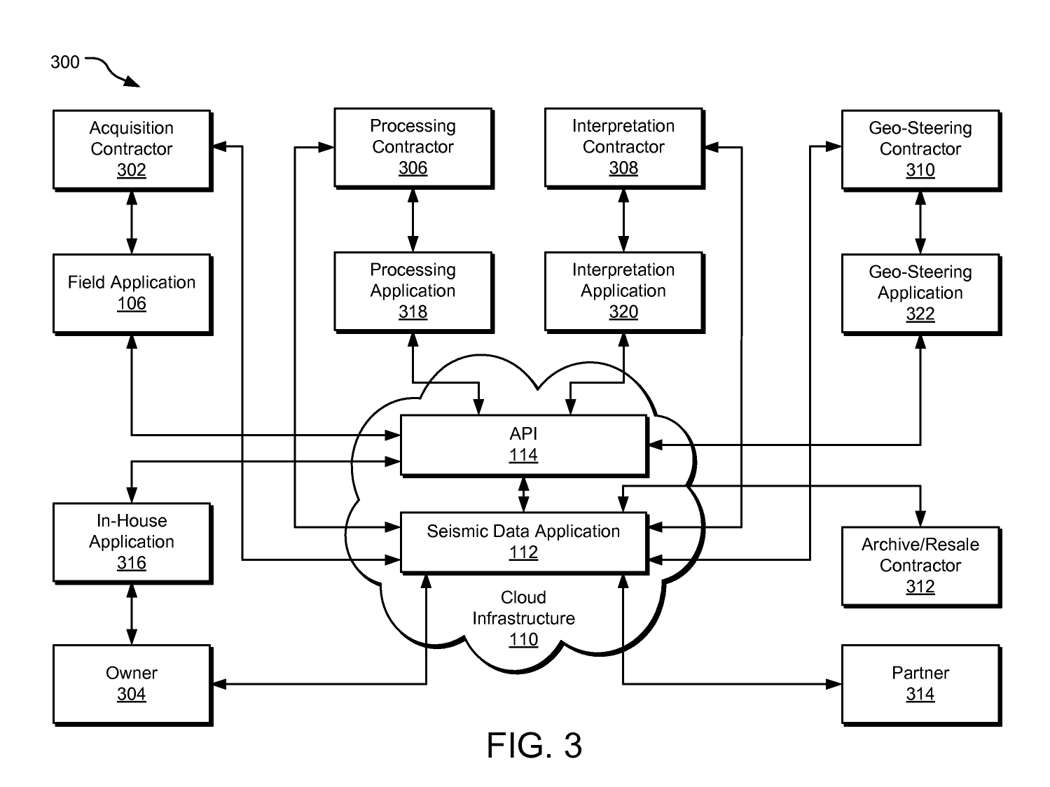

Referring to FIG. 3, an example system 300 for managing the flow of and access to seismic data is shown. As can be understood from FIG. 3 and as described herein, the seismic data application 112 is implemented in the cloud infrastructure 110. The system 300 contemplates a range of possible cloud storage solutions ranging from a dedicated processor, input/output (I/O) and storage, to a processor or processors executing various threads for reading and writing data into and out of a virtualized storage node. The architecture of the cloud infrastructure 110 as well as the storage and retrieval of seismic data in a cloud-based computing architecture is described in detail in one or more of the applications incorporated by reference herein. The cloud-based seismic data application 112 links a plurality of parties via a network (e.g., the Internet) to bring a uniform and controlled process to the acquisition, processing, interpretation, archiving, and sharing of seismic data.

As can be understood from FIG. 3, the system 300 provides an efficient, high speed exchange of massive seismic data and other files and increases collaboration and quality control during the acquisition, processing, and interpretation of the seismic data. Further, the seismic data is secured in the cloud infrastructure 110 where access and operations against the data are controlled using role-based access rights and project status. The seismic data is archived together such that a relationship among field seismic data, ancillary data, processed seismic data, and interpreted seismic data (i.e., processed seismic data and corresponding metadata), among other information is maintained across acquisition, processing, and interpretation projects. Finally, the system 300 provides keyword and spatial lookup for easy locating and accessing of data.

In one implementation, the parties (e.g., an acquisition contractor 302, an owner 304, etc.) may access and interact with the seismic data application 102, directly, for example, through a user device running a browser or other web-service that can interact with the cloud infrastructure 110 by way of the network. The user device is generally any form of computing device, such as a work station, personal computer, portable computer, mobile device, or tablet, capable of interacting with the cloud infrastructure 110.

In another implementation, the parties may access and interact with the seismic data application 112 from software running on the user device utilizing an interface such as an API 114. Stated differently, the API 114 can be called from an application or other software on the user device to pull or push seismic data to and from the cloud infrastructure 110. The seismic data may be accessed in a variety of formats, such as SEG-Y files, or using higher-level constructs, including, but not limited to, lines, images, and map objects. Accessing the seismic data using the API 114 increases efficiency of sharing and working with the seismic data by eliminating or otherwise reducing the need for reformatting data for software that utilizes specific internal formatting for seismic data. Alternatively or additionally, the system 300 may include plug-ins for various software applications to translate the format of the seismic data into the internal formatting required by a particular seismic software application.

The owner 304 is a client that commissioned a seismic survey and that generally owns any proprietary information obtained from the seismic survey, including field seismic data (i.e., shot records), processed seismic data (i.e., data obtained through any alteration or processing of the original field data, such as pre-stack processed data and post-stack processed data), and any interpreted seismic data (i.e., the processed seismic data and metadata, such as notes, annotations, digitized horizons, digitized geologic fault planes, specialized metadata, etc.). Sometimes, the owner 304 will perform one or more of acquisition, processing, interpretation, geo-steering, or archiving services in-house using, for example, an in-house application 316. On the other hand, the owner 304 may hire various contractors 302, 306, 308, 310, and 312 to perform these and other services.

Other interested parties, such as a partner 314, may have access rights to the seismic survey and any associated seismic data. For example, should the partner 314 obtain a license or other rights to access the data of the owner 304, copies of the data are stored in the cloud infrastructure such that they are accessible to the partner 314. In some instances, the partner 314 may also be a contractor that will perform some action on the data set for the owner 304.

The owner 304, the partner 314, and the contractors 302, 306, 308, 310, and 312 may each have their own accounts permitting them to log into the seismic data application 112 to access any seismic surveys that they have created or that have been shared with them. In one implementation, the party may then access surveys, seismic data, and other proprietary data according to access rights and project statuses, which may be defined by the owner 304, an administrator, or another interested party.

On top of security and access control services, the seismic data application 112 brings a uniform and controlled process to the acquisition, processing, interpretation, archiving, and sharing of seismic data. Once the owner 304 creates and activates an acquisition project, the acquisition contractor 302 can connect to the seismic data application 112 directly or from the field application 106, for example, via the satellite 116. The acquisition contractor 302 acquires field seismic data from the survey site, which is often collected as numerous individual shot records and any field condition data and/or ancillary data (e.g., Ob note files, SPS files, and survey files).

The system 300 provides for the acquisition contractor 302 to securely upload and store the field seismic data in the cloud infrastructure 110 as it is acquired. The field seismic data may be encrypted when it is uploaded into the cloud infrastructure 110. In one implementation, the field seismic data is automatically uploaded after each shot is recorded or on regular time intervals. To achieve this, the acquisition contractor 302 may utilize a computing device on-site that is equipped with an IP connection via satellite, cellular networks, or some other means. Each time the shot is recorded, the shot record is copied to a local file directory, where the seismic data application 106 identifies it and executes an upload to the account associated with the survey.

In another implementation, the field seismic data is collected and stored on a portable storage device, which may be connected to a user device for manual upload. For example, the acquisition contractor 302 may travel to a location with an internet connection to log into the seismic data application 112. The acquisition contractor 302 selects the appropriate account and survey and uploads the field seismic data and any ancillary data from the portable storage device.

Once the seismic data application 112 receives the field seismic data, in one implementation, the acquisition contractor 302, the owner 304, and/or other parties are notified. For example, the seismic data application 112 may generate an email to the parties describing the action performed. The seismic data application 112 may further track the accumulated actions of the acquisition contractor 302 and organize the field seismic data acquired into an activity log, which may be accessed by interested parties based on their access rights.

As the acquisition project progresses and field seismic data is collected and uploaded into the cloud infrastructure 110, the owner 304, the partner 314, and/or one or more of the contractors 302, 306, 308, 310, and 312 may view and analyze the field seismic data for quality control and other purposes.

For example, the owner 304 may use the activity log to review each of the previous day's shot records. The seismic data application 112 may include a plurality of display settings allowing the owner 304 to optimize the review by changing scale, gain, agc, bandpass filter, and other settings. Further, the owner 304 may perform a “rubber-band select” using an input device, such as a mouse. The rubber-band select displays a pop-up power spectrum for a portion of the shot record. Additionally, the acquisition contractor 302 may upload test shot records, which are identified as such by the seismic data application 112. The test shot records may be downloaded for specialized analysis.

For each of the shot records, the owner 304 or interested party may indicate that a quality control check has been performed on the field seismic data, whether each of the shot records are acceptable, and/or any feedback on the shot records. For example, wind noise, commercial noise, or other noise occurring during certain times may impact the quality of the field seismic data. The owner 304 may provide feedback noting that the acquisition contractor 302 should collect the field seismic data outside of these certain times.

Once the owner 304 or interested party is satisfied with the quality of the field seismic data, the acquisition project is complete. Once the acquisition project is complete, the owner 304 may download the complete field seismic data or archive the field seismic data in the cloud infrastructure 110 for a processing project.

In one implementation, the owner 106 allows controlled access to the field seismic data and any ancillary data by a processing contractor 306. The processing contractor 306 downloads the field seismic data and ancillary data or processes the data in a processing application 318 by way of the API 114. The processing contractor 306 generates multi-dimensional seismic stack data from the field seismic data. Processed seismic data may refer to data that is obtained through any alteration or processing of the original field data, such as pre-stack processed data and post-stack processed data. Pre-stack and post-stack processed data refer to data that has undergone processing before being coalesced into a final stack and after being coalesced into a final stack, respectively. The seismic data application 112 uploads and stores the processed seismic data in the cloud infrastructure 110. During the processing, the owner 304 or other interested parties may review and analyze the seismic stack data for quality control and other purposes. In one implementation, the owner 304, the processing contractor 306, and/or other interested parties may create annotations in the form of notes and drawings, which are applied directory to and stored with the seismic data. In other words, uploaded attachments and metadata may be stored with and managed along corresponding seismic data.

Once the owner 304 or interested party is satisfied with the quality of the seismic stack data, the processing project is complete. The owner 304 may download the complete seismic stack data or archive the processed seismic data in the cloud infrastructure 110 for an interpretation project. In one implementation, the owner 304 allows controlled access to the processed seismic data by an interpretation contractor 308. The interpretation contractor 308 downloads the seismic stack data or analyzes the data in an interpretation application 320 by way of the API 114. In one implementation, the system 100 includes a plug-in for the interpretation application 320 to translate the format of the seismic data stored in the cloud infrastructure 110 into a format required by the interpretation application 320. The interpretation contractor 308 interprets the data, for example, to identify underground horizons, obtain topographic data, obtain filtered data, and/or obtain fault data. The interpretation contractor 308, the owner 304, and/or other interested parties views the processed seismic data and creates metadata from the processed seismic data. In other words, interpreted seismic data includes processed seismic data and corresponding metadata. The seismic data application 112 uploads and stores the interpreted seismic data in the cloud infrastructure 110. During the interpretation, the owner 304 or other interested parties may review and analyze the interpreted seismic data for quality control and other purposes.

Metadata, for example in the form of annotations, drawings, digitized horizons, digitized geologic fault planes, specialized metadata, etc. on processed seismic data (e.g., on cross-sectional views, map views, etc.), is very important in the oil and gas industry with respect to interpretation services. For example, it is beneficial to have a complete repository for final interpreted seismic data for sharing, viewing, and other collaboration. As such, meta-data created within the seismic data application 112 is retained in the cloud infrastructure 110, and metadata created in the interpretation application 320 may be uploaded to the cloud infrastructure 110. The metadata is stored and managed along with the processed and interpreted seismic data.

Once the owner 304 or interested party is satisfied with the quality of the interpreted seismic data, the interpretation project is complete. Once the interpretation project is complete, the owner 304 may download the interpreted seismic data or archive the interpreted seismic data in the cloud infrastructure 110. Accordingly, the system 300 provides a uniform storage location and directory for aggregating seismic data prior to and including obtaining and interpreting seismic stack data.

In some instances, a geo-steering contractor 310 may be provided access to the seismic data while drilling to adjust a borehole position on the fly to reach one or more geological targets. The geo-steering contractor 310 may access and interact with the seismic data directly or in a geo-steering application 322 by way of the API 114. Finally, an archive/resale contractor 312 may be given access rights to the seismic data to create an additional archive of the seismic data or to sell, license or otherwise transfer the seismic data. The right to transfer may include permission to provide a copy of seismic data or other proprietary data to another party, to license or sub-license the seismic data, or other transfer rights. The seismic data application 112 may track the custody of such data from one party to another as it is transferred, as well as the terms of the transfer. Further, the seismic data application 112 may be configured to require a party to accept or digitally sign a license or transfer contract prior to receiving the seismic or proprietary data.

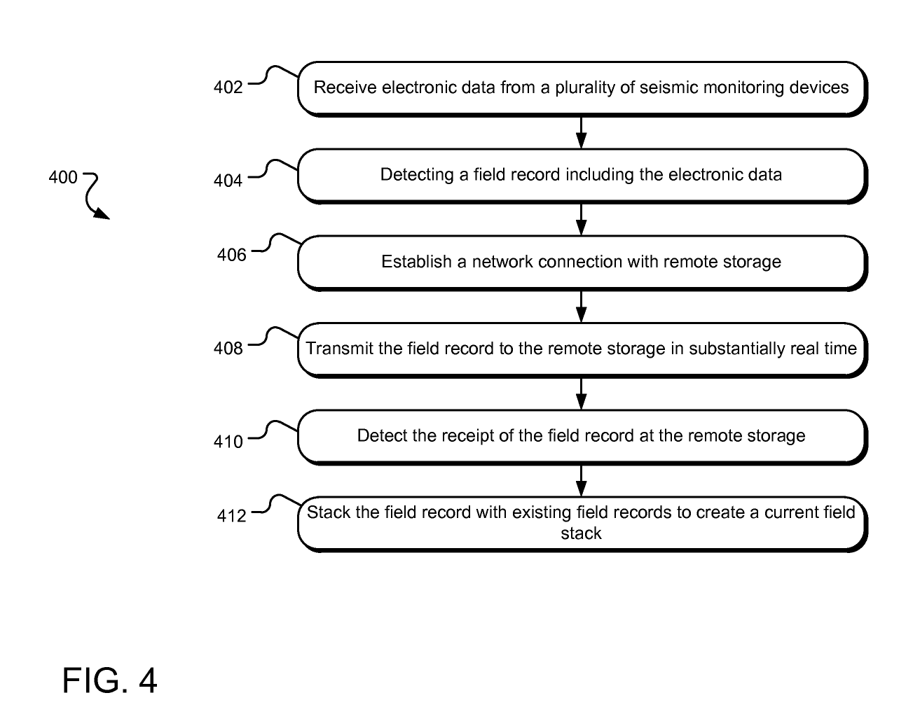

Turning to FIG. 4, a flow chart illustrating example operations 400 for real-time seismic data acquisition management is shown. In one implementation, an operation 402 receives electronic data from a plurality of seismic monitoring devices. An operation 404 analyzes the electronic data and detects a field record. An operation 406 establishes a network connection with remote storage. The monitoring devices may include a geophone and the network connection may include a connection to a satellite. An operation 408 transmits the field record to the remote storage for access in substantially real time. An operation 410 detects the receipt of the field record at the remote storage, and an operation 412 stacks the field record with existing field records to create a current field stack.

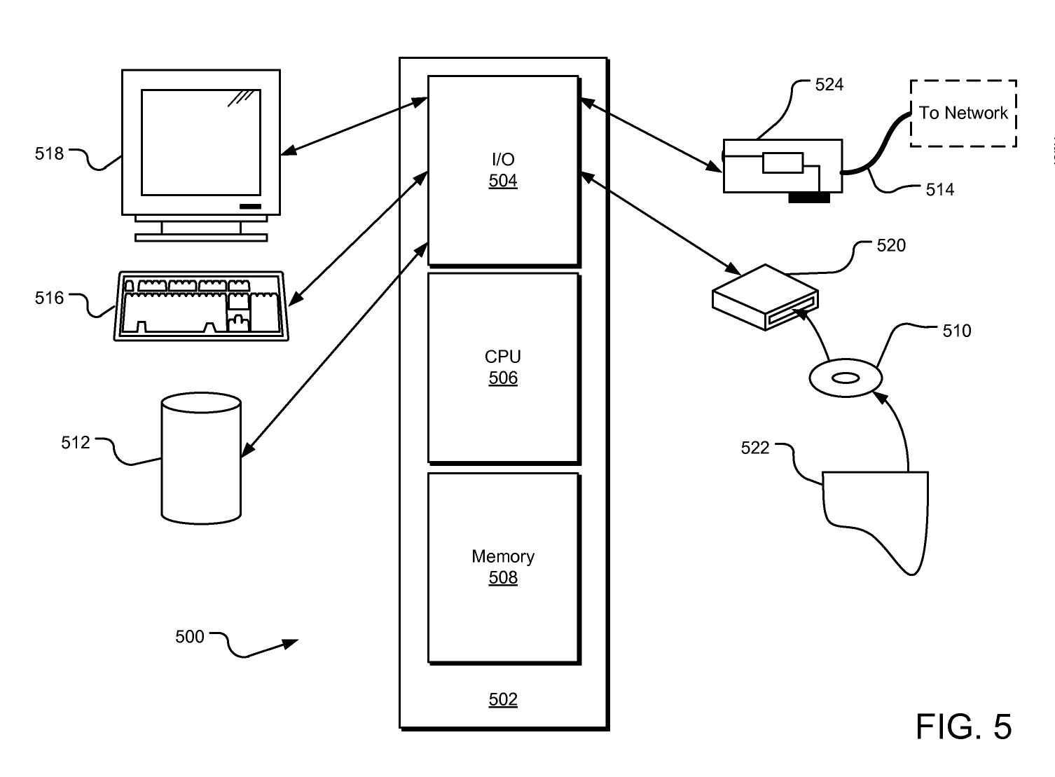

Referring to FIG. 5, a detailed description of an example computing system 500 having one or more computing units that may implement various systems and methods discussed herein is provided. The computing system 500 may be applicable to the user devices 120, the server 124, the acquisition system 102, or other computing devices. It will be appreciated that specific implementations of these devices may be of differing possible specific computing architectures not all of which are specifically discussed herein but will be understood by those of ordinary skill in the art.

The computer system 500 may be a general computing system is capable of executing a computer program product to execute a computer process. Data and program files may be input to the computer system 500, which reads the files and executes the programs therein. Some of the elements of a general purpose computer system 500 are shown in FIG. 5 wherein a processor 502 is shown having an input/output (I/O) section 504, a Central Processing Unit (CPU) 506, and a memory section 508. There may be one or more processors 502, such that the processor 502 of the computer system 500 comprises a single central-processing unit 506, or a plurality of processing units, commonly referred to as a parallel processing environment. The computer system 500 may be a conventional computer, a distributed computer, or any other type of computer, such as one or more external computers made available via a cloud computing architecture. The presently described technology is optionally implemented in software devices loaded in memory 508, stored on a configured DVD/CD-ROM 510 or storage unit 512, and/or communicated via a wired or wireless network link 514 (e.g., the network link 108), thereby transforming the computer system 500 in FIG. 5 to a special purpose machine for implementing the described operations.

The I/O section 504 is connected to one or more user-interface devices (e.g., a keyboard 516 and a display unit 518), a disc storage unit 512, and a disc drive unit 520. In the case of a tablet or smart phone device, there may not be a physical keyboard but rather a touch screen with a computer generated touch screen keyboard. Generally, the disc drive unit 520 is a DVD/CD-ROM drive unit capable of reading the DVD/CD-ROM medium 510, which typically contains programs and data 522. Computer program products containing mechanisms to effectuate the systems and methods in accordance with the presently described technology may reside in the memory section 504, on a disc storage unit 512, on the DVD/CD-ROM medium 510 of the computer system 500, or on external storage devices made available via a cloud computing architecture with such computer program products, including one or more database management products, web server products, application server products, and/or other additional software components. Alternatively, a disc drive unit 520 may be replaced or supplemented by an optical drive unit, a flash drive unit, magnetic drive unit, or other storage medium drive unit. Similarly, the disc drive unit 520 may be replaced or supplemented with random access memory (RAM), magnetic memory, optical memory, and/or various other possible forms of semiconductor based memories commonly found in smart phones and tablets.

The network adapter 524 is capable of connecting the computer system 500 to a network via the network link 514, through which the computer system can receive instructions and data. Examples of such systems include personal computers, Intel or PowerPC-based computing systems, AMD-based computing systems and other systems running a Windows-based, a UNIX-based, or other operating system. It should be understood that computing systems may also embody devices such as terminals, workstations, mobile phones, tablets or slates, multimedia consoles, gaming consoles, set top boxes, etc.

When used in a LAN-networking environment, the computer system 500 is connected (by wired connection or wirelessly) to a local network through the network interface or adapter 524, which is one type of communications device. When used in a WAN-networking environment, the computer system 500 typically includes a modem, a network adapter, or any other type of communications device for establishing communications over the wide area network. In a networked environment, program modules depicted relative to the computer system 500 or portions thereof, may be stored in a remote memory storage device. It is appreciated that the network connections shown are examples of communications devices for and other means of establishing a communications link between the computers may be used.

In an example implementation, seismic data acquisition, management, sharing, storing, retrieving, and security software and other modules and services may be embodied by instructions stored on such storage systems and executed by the processor 502. Some or all of the operations described herein may be performed by the processor 502. Further, local computing systems, remote data sources and/or services, and other associated logic represent firmware, hardware, and/or software configured to control data access. Such services may be implemented using a general purpose computer and specialized software (such as a server executing service software), a special purpose computing system and specialized software (such as a mobile device or network appliance executing service software), or other computing configurations. In addition, one or more functionalities of the systems and methods disclosed herein may be generated by the processor 502 and a user may interact with a Graphical User Interface (GUI) using one or more user-interface devices (e.g., the keyboard 516, the display unit 518, and the user devices 120) with some of the data in use directly coming from online sources and data stores.

Some or all of the operations described herein may be performed by the processor 502. Further, local computing systems, remote data sources and/or services, and other associated logic represent firmware, hardware, and/or software configured to control operations of the seismic data application 112, the user devices 120, and/or other computing units or components of the system 100. Such services may be implemented using a general purpose computer and specialized software (such as a server executing service software), a special purpose computing system and specialized software (such as a mobile device or network appliance executing service software), or other computing configurations. In addition, one or more functionalities disclosed herein may be generated by the processor 502 and a user may interact with a Graphical User Interface (GUI) using one or more user-interface devices (e.g., the keyboard 516, the display unit 518, and the user devices 104) with some of the data in use directly coming from online sources and data stores. The system set forth in FIG. 5 is but one possible example of a computer system that may employ or be configured in accordance with aspects of the present disclosure.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

The description above includes example systems, methods, techniques, instruction sequences, and/or computer program products that embody techniques of the present disclosure. However, it is understood that the described disclosure may be practiced without these specific details.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method of managing seismic exploration data acquisition comprising:
receiving seismic data captured using one or more monitoring devices at a remote seismic exploration project site;
detecting a seismic field record in the captured seismic data automatically using at least one processor;
establishing a network connection with a cloud storage array; and
sending the detected seismic field record automatically to the cloud computing array over the network connection.

2. The method of claim 1, wherein the network connection includes a satellite connection.

3. The method of claim 1, wherein the one or more monitoring devices includes a geophone.

4. The method of claim 1, wherein detecting the seismic field record includes monitoring a files system directory to which the captured seismic data is written.

5. The method of claim 1, wherein the detected seismic field record is automatically sent to the cloud computing array by uploading the detected seismic field record to the satellite and downloading the detected seismic field record to the cloud computing array.

6. The method of claim 1, wherein the seismic data includes field condition data and ancillary data.

7. The method of claim 1, wherein the one or more monitoring devices includes a weather monitoring device configured to capture weather conditions at the remote seismic exploration site.

8. A seismic exploration data acquisition management system comprising:
an acquisition system having at least one processor configured to automatically detect a seismic field record in seismic data captured using one or more monitoring devices at a remote seismic exploration project site and to automatically upload the seismic field record to a satellite upon detection; and
a cloud storage array configured to automatically download the seismic field record from the satellite and to automatically process the seismic field record for inclusion in a seismic field stack.

9. The seismic exploration data acquisition management system of claim 8, wherein the seismic field record is automatically processed by associating the seismic field record with one or more existing seismic field records stored in the cloud storage array and stacking the seismic field record with the one or more existing seismic field records to create the seismic field stack.

10. The seismic exploration data acquisition management system of claim 8, wherein the seismic field record is automatically processed by performing a quality control of the seismic field record.

11. The seismic exploration data acquisition management system of claim 10, wherein the quality control includes analyzing the seismic field record for noise by generating a signal to noise ratio and comparing the signal to noise ratio to a threshold.

12. The seismic exploration data acquisition management system of claim 10, wherein a notification is generated using at least one processor and sent to the acquisition system where the signal to noise ratio exceeds the threshold.
